(19) United States
(12) Patent Application Publication
(10) Pub. No.: US 2002/0047045 A1
(43) Pub. Date: Apr. 25, 2002

(54) Embedded smart card reader for handheld-computing devices

(75) Inventors: Song Song, Beijing (CN); Jun Shen, Beijing (CN); Rongyao Fu, Beijing (CN)

Correspondence Address: IBM CORPORATION, INTELLECTUAL PROPERTY LAW DEPT., P.O. Box 218, YORKTOWN HEIGHTS, NY, 10598, US

(73) Assignee: International Business Machines Corporation, Armonk, NY

(21) Appl. No.: 09/978,945

(22) Filed: Oct. 16, 2001

(30) Foreign Application Priority Data
Oct. 25, 2000 (CN) 00131964.7

(51) Int. Cl. G06K 7/06

(52) U.S. Cl. 235/441

(57) ABSTRACT

An embedded Smart Card reader for a handheld-computing device. In an example embodiment the invention comprises a protocol implementation unit connected to communicate with an I/O port of an expansion slot of the handheld-computing device; a first Smart Card interface unit connected to the protocol implementation unit; and a first installation, connected to the smart card interface unit, for securing the Smart Card. This reader has the advantageous of small size, low power consumption and high performance of security.

### FIELD OF THE INVENTION

The present invention relates in general to a smart card reader, and in particular, to a smart card reader used for handheld-computing devices.

### BACKGROUND

Personal Digital Assistant (PDA), e.g., PalmPilot/WorkPad, is one of the most popular handheld-computing devices today. According to International Data Corp. (IDC), Palm products hold a 70 percent share of the worldwide handheld-computing market. Originally the device is used as a personal digital assistant for storing appointments, phone numbers and other personal management information, but now at the Internet Age enterprise and consumer business transaction are being dramatically reshaped by the pervasive influences of the Word Wide Web. More and more handheld-computing devices are used in these kinds of e-business applications such as stock trading, wireless banking, conducting e-commerce or transmitting proprietary enterprise information by providing access to Internet or Intranet anywhere and anytime. E-business applications demand strong security to protect data and communication for business and individual.

However, handheld-computing devices are not a secure system to meet such kind of requirement. For example, the CPU of a handheld-computing device is generally not powerful enough to provide efficient implementation of cryptographic algorithms such as RSA; therefore it is difficult for it lo provide authentication, confidentiality and message integrity efficiently to secure data communication. In addition, it is difficult to ensure the sensitive data in the memory of a handheld-computing device is safe even when the handheld-computing device is lost or the batteries are exhausted.

In order to overcome this challenge, a Smart Card Enabled PalmPilot, 'WorkPad technique (SCEPW) is proposed. SCEPW, which integrates the smart card into WorkPad/PalmPilot to enhance the security of this handheld-computing device, provides various security mechanisms without restriction of the CPU power of handheld-computing devices.

Smart cards are plastic cards equal in size and shape to credit cards, only different in that they bear a microprocessor including memory. These hardware capabilities in general allow for secure processing and storage of key and data objects which might be too exposed by using magnetic coding or printed information on the card directly. As we know, the smart card itself is a very secure system. It is easy to use, portable, and unique and can't be cloned. Its use is Personal Identification Number (PIN) protected, and it becomes completely unusable after a specified number of failed access attempts. Smart cards offer superior protection for personal important information such as digital certificates, private keys for encryption algorithms because smart cards require not only a password (PIN) but also physical possession of the card to gain use of the information. This kind of two-factor authentication offers significantly stronger security than passwords, and ensures that the sensitive information is used only by its rightful, intended owner. Furthermore, many smart cards also provide some standard cryptographic algorithms such as DES, RSA and DSA used for authentication, digital signature and data encryption. As coprocessors are deployed in these smart cards to complete these algorithms, they can provide better performance than pure software implementation. Because smart cards are very cheap and secure, now they have been widely used in telecommunications, banking and other applications. Therefore it is an object of the invention to use smart cards to achieve an efficient cryptography solution on handheld-computing devices. Because of the strong security and portable usage of the smart card, the invention will greatly enhance the security of the handheld-computing devices. However, the handheld-computing devices are so small that they could only provide limited space and power for extending devices.

In addition, in general, a handheld-computing device doesn't provide a slot to insert a smart card. It has a memory expansion slot inside and a serial communication port outside to connect modem, and other peripheral devices. If the serial port is occupied by a smart card reader, connection to a modem will not be possible and the functions of the handheld-computing device will be limited.

Moreover, handheld-computing devices are generally powered by batteries which generally provide low power. Therefore, it is desired to have a low-consumption smart-card reader.

### SUMMARY OF THE INVENTION

Therefore one aspect of the invention is to provide an embedded smart card reader for handheld-computing devices installed into their inside expansion slot.

A second aspect of the invention is to provide an embedded smart card reader in which a serial communication protocol is deployed to transmit data between the smart card reader and the handheld-computing device. The serial communication could reduce the number of hardware components and thus to make the device smaller.

A third aspect of the invention is to provide a low power-consumption smart card reader via only consuming power when the card is in operation.

A forth aspect of the present invention is to provide a smart card reader which can provide two smart card slots to enhance the security of handheld-computing devices.

To implement the above aspects, the invention provides an embedded smart card reader for a handheld-computing device, comprising a communication protocol implementation unit connected to an I/O port of an expansion slot of the handheld-computing device; A first smart card interface unit connected to the protocol implementation unit; And a first installation connected to the smart card interface unit for securing the smart card.

To implement the above aspects, the invention further provides an embedded smart card reader for a handheld-computing device, characterized in that the communication between the card reader and the handheld-computing device is conducted in series.

To implement the above aspects, the invention further provides an embedded smart card reader for a handheld-computing device, characterized by further comprising a power control unit connected to a voltage conversion unit, for supplying the smart card reader with power only when the card reader is in operation.

To implement the above aspects, the invention further provides an embedded Smart Card reader for a handheld-computing device, characterized by further comprising a second smart card interface unit connected to the protocol implementation unit.

### BRIEF DESCRIPTION OF DRAWINGS

In the following, the invention will be described in more detail with reference to the appended drawings, in which:

FIG. 1 is a schematic diagram showing a first advantageous embodiment of the invention;

FIG. 2 shows the connections of an I/O expansion slot to a communication protocol implementation unit in the first implementation;

FIG. 3 is a timing diagram showing how to implement a serial communication protocol;

FIG. 4 shows another advantageous embodiment of the invention;

FIG. 5 illustrates the concept of bi-directional authentication;

FIG. 6 shows an implementation of a card reader according to the invention;

FIG. 7 illustrates the hardware architecture between a smart card, a smart card reader and an expansion slot of a handheld-computing device;

FIG. 8 shows the circuit layout according to the implementation of FIG. 6;

FIG. 9 is a picture showing the system according to the invention; and

FIG. 10 shows a card reader physically connected to the handheld-computing device according to the invention.

### DETAILED DESCRIPTION OF THE INVENTION

An advantageous embodiment of the invention will be described with reference to IBM WorkPad in which an internal expansion slot is originally designed for a memory unit. Persons skilled in the art will learn from detailed description of the advantageous embodiment of the invention that solution of the invention can be applied into any types of handheld-computing devices having therein an expansion slot with an I/O port. In addition, the term “hand-computing device” used in the specification refers to PalmPilot/WorkPads, any kinds of PDA, and the like.

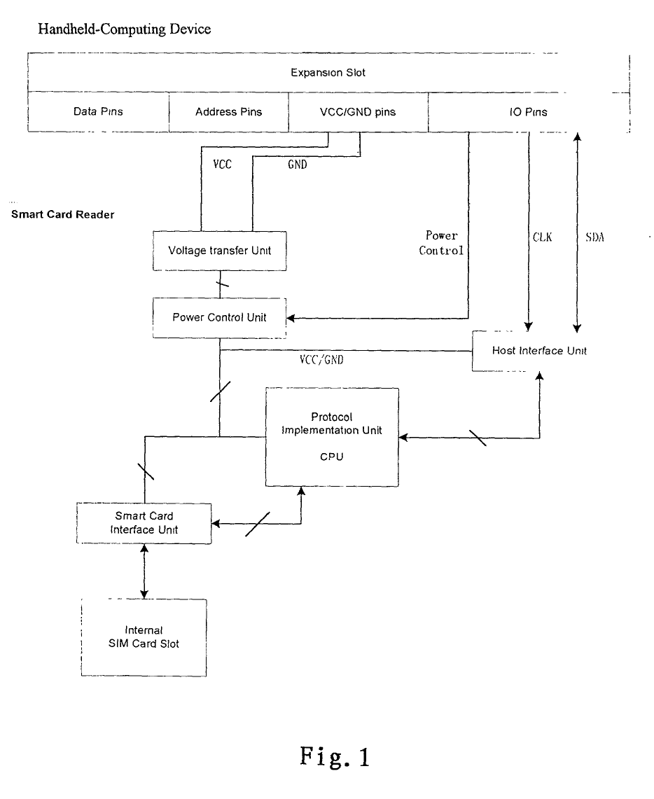

FIG. 1 shows the scheme of a first advantageous embodiment of the invention. As shown in FIG. 1, the expansion slot on the handheld-computing device WORKPAD includes data pins, address pins, VCC/GND pins and I/O pins. The VCC/GND pins on the expansion slot are connected to the voltage transfer unit of the card reader. The voltage transfer unit transfers for example a 3 V voltage into a 5 V voltage, depending on the case may be. In cases where the voltage provided by the handheld device is the same as the voltage required by operation of the card reader, the voltage transfer unit may be omitted. In other particular circumstances, it's possible that parts of components of the card reader operate under the same voltage as those provided by the handheld-computing device, and other parts operate under a different voltage. In such a case, a voltage transfer unit is required for those parts operating under the different voltage. The voltage provided by the handheld-computing device is generally 3V. Therefore, it is advantageous to design the operation voltage of the components of the card reader as 3 V. The operation voltage of a Smart Card is typically 5 V, and thus a voltage transfer unit is required to provide a conversion from 3 V to 5 V. A power control unit is serially connected with the voltage transfer unit. The power control unit is used to control the power supply for the card reader as a function of a power control signal from one of the I/O pins. Though it's not a necessity that the power control signal be output from the I/O pins, it will be advantageous because the circuit of the smart card reader can then be simplified due to avoidance of flip-latches. Power output from the power control unit will be supplied to components of the card reader. It will be appreciated by persons skilled in the art that the power control unit is not a necessity in cases where power-consumption is not a requirement. As an example, the power control circuit may be a simple switch circuit comprised of a transistor. In this embodiment, the other two pins of the I/O port are defined as a signal line CLK and a serial data line SDA respectively. In other cases where there are much more I/O pins, the data may be designed to transmit in parallel. Though the circuit will become much complex due to this, the transmission rate can be improved. The clock signal line and the serial data line are connected to a protocol implementation unit via a host interface unit. The host interface unit may be part of the protocol implementation unit, for example, be a communication port, a serial port, several lines of a parallel port of the protocol implementation unit. A smart card interface unit is connected to the protocol implementation unit. The communication between the smart card interface unit and the protocol implementation unit are well known to persons skilled in the art and the detailed description thereof will be omitted. The smart card interface unit and the protocol implementation unit are available on market and are well known to persons skilled in the art. A smart card slot, which in this advantageous embodiment is an internal SIM card slot, is connected to the smart card interface unit. An advantage of such kind of slot is that it is small in size and easy for taking. In other particular cases, the card slot may be replaced by a smart card connector for detachably connecting with external cards which are generally equal in size to credit cards.

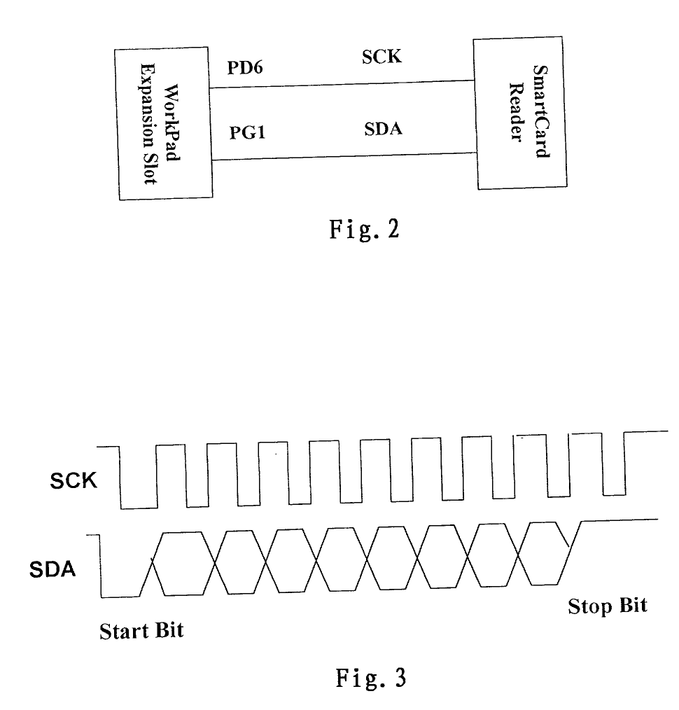

FIG. 2 shows the connection of an I/O expansion slot to a communication protocol implementation unit in the first advantageous embodiment. As shown in FIG. 2, the PD6 pin of the expansion slot of WorkPad is defined as a signal line SCK, and the PG1 pin is defined as a data line. During a communication, the WorkPad acts as a master controller. When the communication is idle, the master controller sets the CLK and SDA at a high level. At the beginning of a communication, the master controller sets the SDA at low voltage to initiate a start bit, followed by eight (8) bits of data, and an end bit. Data is transmitted at falling edges of the CLK respectively. The card reader checks the state of the SDA constantly, and where a low level is detected, begins to receive data. After the communication is completed, the master controller sets the SCK line and SDA line at a high voltage, waiting for a result from the card reader. A receiving procedure is similar to the transmitting procedure.

FIG. 3 is a timing chart of the serial communication according to the first embodiment of the invention. FIG. 3 shows a case where an asynchronous communication is conducted. Alternatively, the communication may be a synchronous communication. Persons skilled in the art may implement other kinds of communication modes.

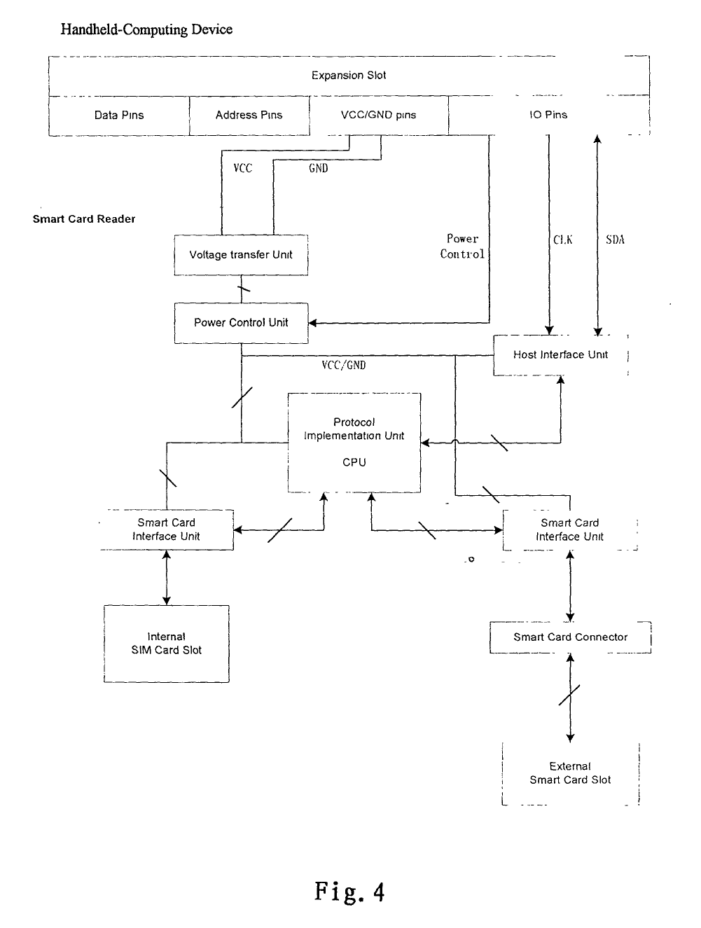

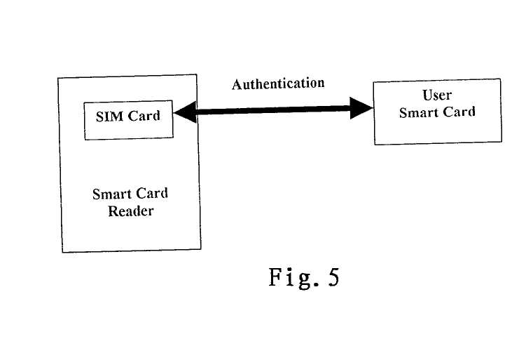

FIG. 4 shows another advantageous embodiment of the invention. As can be seen from FIG. 4, a second smart card interface unit is connected to the protocol implementation unit, and a smart card connector for connecting with an external smart card is connected to the second smart card interface unit. In other embodiments of the invention, the second smart card may also be an internal smart card such that an internal SIM card slot should replace the smart card connector. There are primarily two advantages for the use of the second smart card. Firstly, the first smart card (preferably an internal SIM card) is normally used by a user and therefore the card can be constantly hosted in the card reader, such that it's not necessary to take the card out or insert the card in often. However, in many application cases, it's necessary to change the smart card often. For example in public applications such as where an IC card reader is used by a traffic policeman, the IC card reader needs to read cards of different users. In such a case, it is preferable that the smart card is in normal size and is easy to be inserted in and pulled out. Thus it can be seen that the card reader can be used in a wider range and be more convenient to users due to the fact that it supports two cards simultaneously. Another advantage of the two-card embodiment is an improved security of the system. The card reader can then be used in applications such as e-business in which a high level of security is required. The two cards may be used in such a way: an internal SIM card is constantly held in a smart card reader and acts as an identification of the smart card reader; before the smart card reader can read/write data from/to a user (external) card, the smart card reader should pass an authentication between the internal smart card and the user card. For example, in a financial system, before the card reader can read data from a smart card of a user, the smart card of the user will authenticate whether the reader is valid. Since the card reader has a SIM card issued by a bank, the validity of the reader can be authenticated by checking the validity of the SIM card. In such a case, the SIM card serves as an identification of the bank issuing the user card. Of course, the SIM card can also check the validity of the smart card of the user. Thus it can be seen that since the card reader supports two cards, the security level of the system is significantly improved. If a card reader doesn't support two cards, the bi-directional authentication between the smart card of the user and the card reader cannot be performed. The concept of bi-directional authentication is illustrated in FIG. 5.

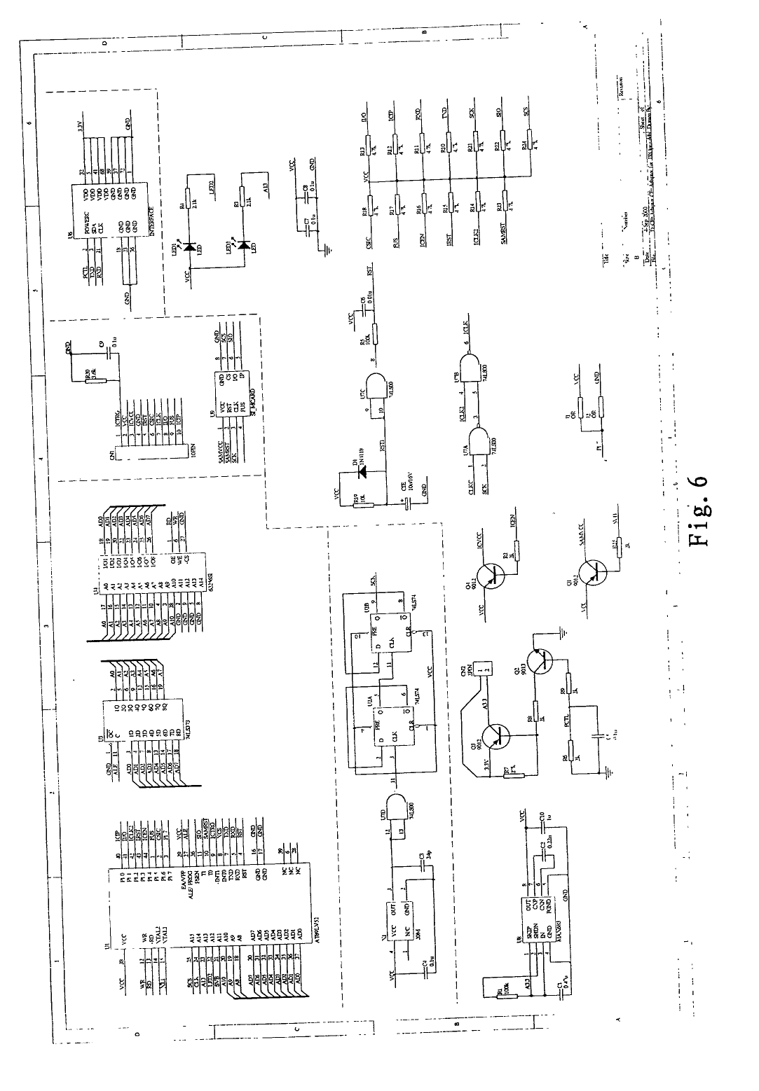

FIG. 6 is an implementation of a card reader according to the invention. In FIG. 6, U1 is an AT89LV52, 51 series monolithic processor for implementing the communication protocol between the card reader and the handheld-computing device and the communication protocol between the card reader and the smart card. U2 is a 74LS74, D-trigger for frequency dividing the clock signal. U3 is a 74LS373 data flip-latch. U4 is a 63356SI SRAM chip for expanding the memory of the monolithic processor. U8 is a MAX683, 3 V/5 V voltage transfer circuit. Q1, Q2, Q3, Q4 are transistors, which form a power control switch circuit.

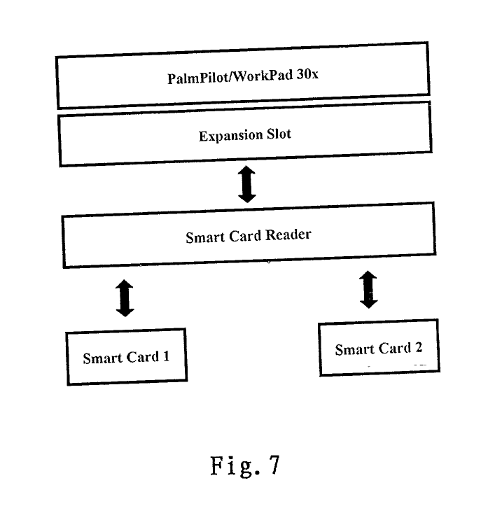

FIG. 7 is a block chart showing the hardware architecture between a smart card, a smart card reader and the expansion slot of a handheld-computing device. FIG. 7 also shows that the smart card 1 and smart card 2 communicate with the handheld-computing device via an embedded card reader.

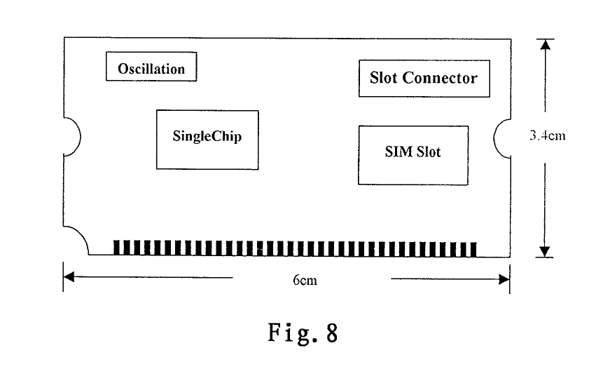

FIG. 8 illustrates a physical layout according to the implementation of FIG. 6. The card reader is 60 mm long, 34 mm wide and 3 mm high. Since the space between the mother board of the WorkPad and the smart card reader board is very small, less than 1.5 mm, most components of the smart card reader, such as the SIM slot, the connector for external smart cards, the protocol implementation unit (CUP) and etc, are located on the upside. In this design, the SIM card slot is used to host a SIM card to reduce the dimension of the reader. In order to support normal-size smart cards, a connector, which can control another smart card slot attached to the workPad, is designed on the board. It is located at the edge of the board so that it is easy for the connector to connect the outside smart card cradle with cable. On the other hand, the SIM slot is placed somewhat inside than the connector because a SIM card always stays in the slot and it's not necessary to often take a card away or insert a card into the slot. As for the downside, only some small components such as resistors and transistors are placed on it.

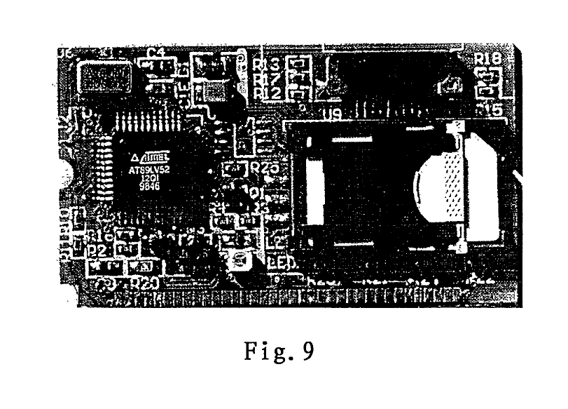

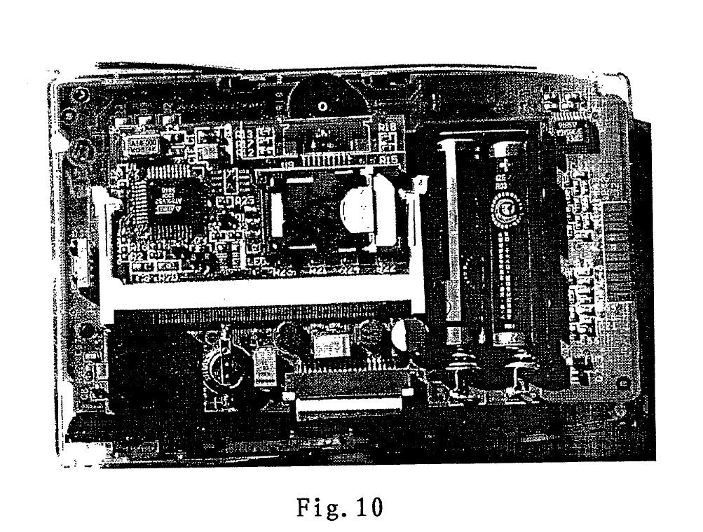

FIG. 9 is a picture showing the system according to the invention, and FIG. 10 shows a condition in which the card reader is physically connected to the handheld-computing device.

While the concept of the invention has been described with reference to particular embodiments, persons skilled in the art may make modifications, changes and improvements without departing from the scope of the invention. For example, components separately described in the specification may be integrated together, and components described as a unit respectively may be implemented by discrete components. The above description is used to illustrate, but not to limit the invention in any aspects.

We claim:

1. An embedded Smart Card reader for a handheld-computing device, comprising:
a protocol implementation unit connected to communicate with an I/O port of an expansion slot of the handheld-computing device;
a first Smart Card interface unit connected to the protocol implementation unit; and
a first installation, connected to the smart card interface unit, for securing the Smart Card.

2. An embedded Smart Card reader as recited in claim 1, characterized by further comprising a second smart card interface unit and a second installation connected to the second Smart Card interface for securing a second Smart Card.

3. An embedded Smart Card reader as recited in claim 2, characterized in that one of the first and second installation is used to secure an internal SIM card, and the other is used to connect an external normal size Smart Card.

4. An embedded Smart Card reader as recited in claim 1, characterized in that the communication between the protocol implementation unit and the I/O port of the handheld-computing device is conducted in series.

5. An embedded Smart Card reader as recited in claim 1, characterized by further comprising a power control unit for supplying the Smart Card reader with voltage only when necessary.

6. An embedded Smart Card reader as recited in claim 4, characterized by further comprising a power control unit for supplying the Smart Card reader with voltage only when necessary.

7. An embedded Smart Card reader as recited in claim 1, characterized by further comprising a voltage transfer unit for converting the voltage from the expansion slot into a voltage for components of the reader.

8. An embedded Smart Card reader as recited in claim 5 , characterized by further comprising a voltage transfer unit for converting the voltage from the extension slot into a voltage suit for components of the reader.

9. An embedded Smart Card reader as recited in claim 1, characterized in that said expansion slot is an expansion slot for memory.
